(19) United States
(12) Patent Application Publication
(10) Pub. No.: US 2021/0303194 A1
(43) Pub. Date: Sep. 30, 2021

(54) MIGRATING AND RECALLING FILES FOR DEEP LEARNING APPLICATIONS

(71) Applicant: International Business Machines Corporation, Armonk, NY (US)

(72) Inventors: Sosuke Matsui, Tokyo (JP); Tsuyoshi Miyamura, Yokohama-shi (JP); Hiroshi Itagaki, Yokohama-shi (JP); Tohru Hasegawa, Tokyo (JP); Shinsuke Mitsuma, Tokyo (JP); Noriko Yamamoto, Tokyo (JP)

(21) Appl. No.: 16/832,096

(22) Filed: Mar. 27, 2020

(51) Int. Cl. G06F 3/06; G06N 3/04

(52) U.S. Cl. CPC G06F 3/0647; G06N 3/04; G06F 3/067; G06F 3/0604

(57) ABSTRACT

Deep learning applications access modified files stored in high speed storage. The modified files are custom formatted for use by deep learning applications to minimize file size. Parent files from which the modified files are made are stored in low speed storage as files having the original characteristics of the parent files. Requesters identified as deep learning applications are provided access to the modified files in high speed storage. Requesting applications not identified as deep learning applications receive the parent files via conventional processing from low speed storage.

### BACKGROUND

The present invention relates generally to the field of machine learning, and more particularly to deep learning.

Deep learning, also known as deep structured learning or differential programming, is part of a broader family of machine learning methods based on artificial neural networks with representation learning. Learning can be supervised, semi-supervised, or unsupervised. Deep learning architectures include deep neural networks, deep belief networks, recurrent neural networks, and convolutional neural networks. These architectures have been applied to various fields including computer vision, speech recognition, natural language processing, audio recognition, social network filtering, machine translation, bioinformatics, drug design, medical image analysis, material inspection, and board game programs where they have produced results comparable to and, in some cases, surpassing human expert performance.

A stub file is a computer file that appears to the user as being on a disk and immediately available for use but is actually held either in part or entirely on a different storage medium. When a stub file is accessed, device driver software intercepts the access, retrieves the data from its actual location, and writes the data to the file, then allows the user access to proceed. Typically, users are unaware that the data is stored on a different medium, though they may experience a slight delay when accessing such a file.

Hierarchical Storage Management (HSM) is a technique to store frequently accessed data to a high-speed (and expensive) storage and infrequently accessed data to a low-speed (and cheap) storage to manage data efficiently. Commercially available storage products support HSM.

When a file data is written to an HSM managed storage, it will be stored in a high-speed storage. Then, the file is copied to a low-speed storage (this step is called pre-migration). Next, an infrequently accessed file is removed from the high-speed storage (this step is called migration). When the HSM managed storage receives a read request of a migrated file, it will be copied from the low-speed storage to the high-speed storage (this step is called recall).

On one hand, HSM manages a large amount of data efficiently. On the other hand, if data is recalled from a low-speed storage, a user needs to wait for the data to be recalled to a high-speed storage. To resolve this problem, there is a known technique to store the data to high-speed storage. The partially stored file in high-speed storage is called “stub”.

If training image data for deep learning is stored in an HSM managed storage system, data can be recalled from a low-speed storage for learning. Researchers have proposed to accelerate the learning speed of deep learning by distributing tasks to many servers or reducing numerical precisions, but these techniques cannot be applied until all training data is recalled from a low-speed storage.

It is well known that the training image size can be 128×128 for image classification purposes by deep learning. To read training date efficiently, you can resize the image before storing it to storage. If you store a resized image to storage, it will not take long time to recall it from low-speed storage to high-speed storage. However, you need to have a rule to maintain a relationship between the resized image data and the original image data (for example, you can give the same name to both image data, but you need to give a different suffix). In addition, both the original image and the resized image is copied to low-speed storage. You can also store only the resized image to your storage. The amount of data stored in storage would become small, but if you need a high-resolution image in the future, you need to collect new training data again.

### SUMMARY

According to an aspect of the present invention, there is a method, computer program product and/or system that performs the following operations (not necessarily in the following order): (i) identifying a parent file stored on a high-speed storage device that may be processed by a first application; (ii) generating a metadata tag for the parent file, the metadata tag including a set of file attributes required by the first application; (iii) responsive to a determination to migrate the parent file from a high-speed storage device to a low-speed storage device, creating a modified file from the parent file, the modified file having attributes matching the set of file attributes described in the metadata tag; and (iv) storing the modified file in the high-speed storage device.

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system;

FIG. 4 is a screenshot view generated by the first embodiment system;

FIG. 5 is a flowchart according to an embodiment of the present invention; and

FIG. 6 is a flowchart according to an embodiment of the present invention.

### DETAILED DESCRIPTION

Some embodiments of the present invention are directed to deep learning applications access modified files stored in high speed storage. The modified files are custom formatted for use by deep learning applications to minimize file size. Parent files from which the modified files are made are stored in low speed storage as files having the original characteristics of the parent files. Requesters identified as deep learning applications are provided access to the modified files in high speed storage. Requesting applications not identified as deep learning applications receive the parent files via conventional processing from low speed storage.

This Detailed Description section is divided into the following subsections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

A “storage device” is hereby defined to be anything made or adapted to store computer code in a manner so that the computer code can be accessed by a computer processor. A storage device typically includes a storage medium, which is the material in, or on, which the data of the computer code is stored. A single “storage device” may have: (i) multiple discrete portions that are spaced apart, or distributed (for example, a set of six solid state storage devices respectively located in six laptop computers that collectively store a single computer program); and/or (ii) may use multiple storage media (for example, a set of computer code that is partially stored in as magnetic domains in a computer's non-volatile storage and partially stored in a set of semiconductor switches in the computer's volatile memory). The term “storage medium” should be construed to cover situations where multiple different types of storage media are used.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

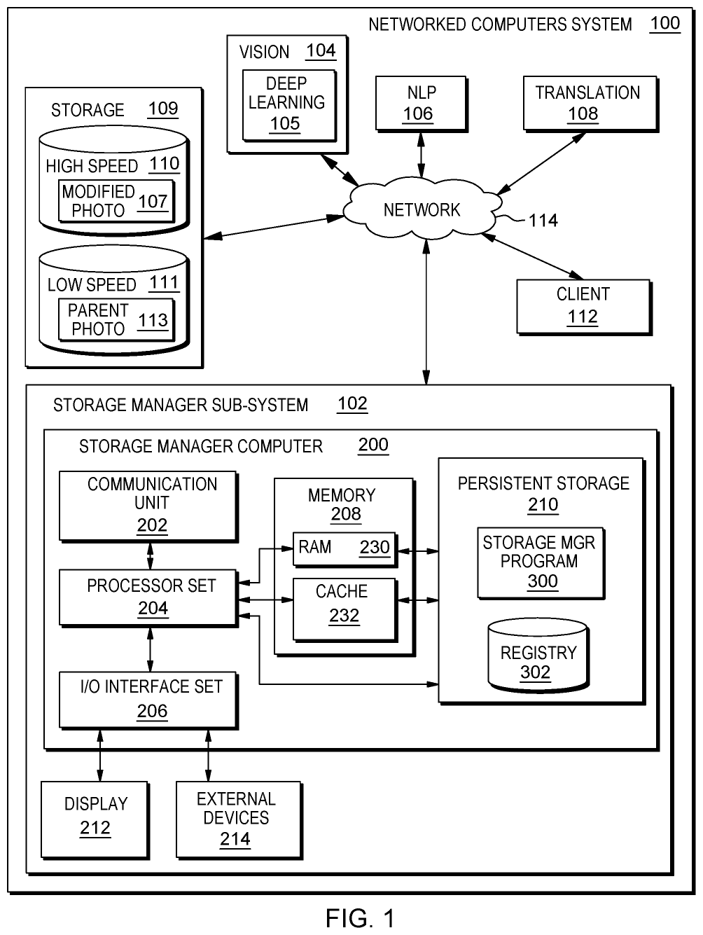

As shown in FIG. 1, networked computers system 100 is an embodiment of a hardware and software environment for use with various embodiments of the present invention. Networked computers system 100 includes: storage manager subsystem 102 (sometimes herein referred to, more simply, as subsystem 102); vision sub-system 104; which includes deep learning application 105; natural language processing (NLP) sub-system 106; language translation sub-system 108; storage sub-system 109; high speed storage 110; modified photo 107; low speed storage 111; parent photo 113; client sub-system 112; and communication network 114. Subsystem 102 includes: storage manager computer 200; communication unit 202; processor set 204; input/output (I/O) interface set 206; memory 208; persistent storage 210; display 212; external device(s) 214; random access memory (RAM) 230; cache 232; storage manager program 300, and registry 302.

Many of the characteristics of sub-systems 104, 106, 108, 109, and 112 are characteristics shared among the various sub-systems, the discussion that follows focuses on sub-system 102, but it should be noted that each sub-system generally operates as described communicating over a network and having memory components, and so forth. Additional details will be presented throughout this Detailed Description that may distinguish the various sub-systems. Subsystem 102 may be a laptop computer, tablet computer, netbook computer, personal computer (PC), a desktop computer, a personal digital assistant (PDA), a smart phone, or any other type of computer (see definition of “computer” in Definitions section, below). Program 300 is a collection of machine readable instructions and/or data that is used to create, manage and control certain software functions that will be discussed in detail, below, in the Example Embodiment subsection of this Detailed Description section.

Subsystem 102 is capable of communicating with other computer subsystems via communication network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client subsystems.

Subsystem 102 is shown as a block diagram with many double arrows. These double arrows (no separate reference numerals) represent a communications fabric, which provides communications between various components of subsystem 102. This communications fabric can be implemented with any architecture designed for passing data and/or control information between processors (such as microprocessors, communications and network processors, etc.), system memory, peripheral devices, and any other hardware components within a computer system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for subsystem 102; and/or (ii) devices external to subsystem 102 may be able to provide memory for subsystem 102. Both memory 208 and persistent storage 210: (i) store data in a manner that is less transient than a signal in transit; and (ii) store data on a tangible medium (such as magnetic or optical domains). In this embodiment, memory 208 is volatile storage, while persistent storage 210 provides nonvolatile storage. The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202 provides for communications with other data processing systems or devices external to subsystem 102. In these examples, communications unit 202 includes one or more network interface cards. Communications unit 202 may provide communications through the use of either or both physical and wireless communications links. Any software modules discussed herein may be downloaded to a persistent storage device (such as persistent storage 210) through a communications unit (such as communications unit 202).

I/O interface set 206 allows for input and output of data with other devices that may be connected locally in data communication with storage manager computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. I/O interface set 206 also connects in data communication with display 212. Display 212 is a display device that provides a mechanism to display data to a user and may be, for example, a computer monitor or a smart phone display screen.

In this embodiment, program 300 is stored in persistent storage 210 for access and/or execution by one or more computer processors of processor set 204, usually through one or more memories of memory 208. It will be understood by those of skill in the art that program 300 may be stored in a more highly distributed manner during its run time and/or when it is not running. Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

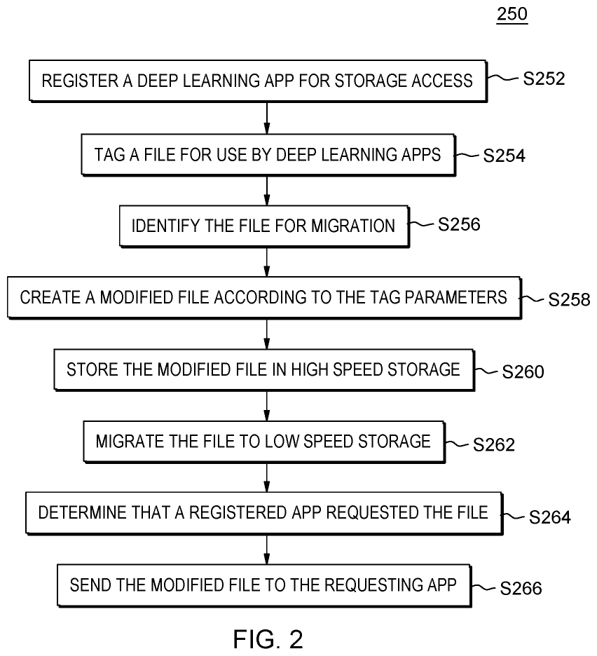

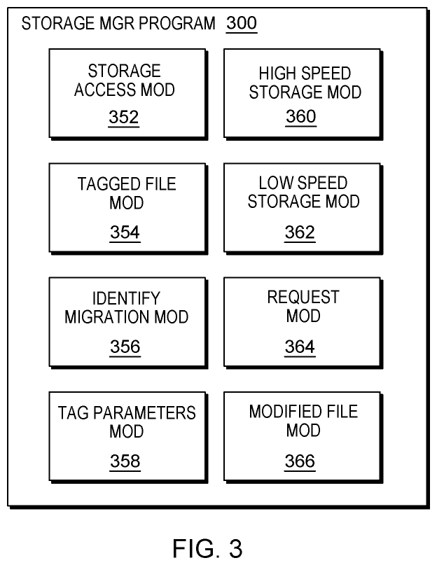

As shown in FIG. 1, networked computers system 100 is an environment in which an example method according to the present invention can be performed. As shown in FIG. 2, flowchart 250 shows an example method according to the present invention. As shown in FIG. 3, program 300 performs or control performance of at least some of the method operations of flowchart 250. This method and associated software will now be discussed, over the course of the following paragraphs, with extensive reference to the blocks of FIG. 1 (system of an embodiment of a hardware and software environment), FIG. 2 (method of operation blocks) and FIG. 3 (software blocks).

Processing begins at operation S252, where storage access module (“mod”) 352 registers a deep learning app (application) for storage access. In this example, storage access mod 352 within storage manager program 300 establishes communication with deep learning application 105 and registry 302 over network 114 to register the deep learning application. This communication accomplishes the registration operation for later identification of deep learning applications when file access requests are received. As shown in FIG. 1, deep learning applications may be associated with various sub-systems for which a storage manager handles files. In this example, vision sub-system 104 includes deep learning application 110. Other sub-systems include, for example, natural language processing (NLP) sub-system 106 and language translation sub-system 108.

Processing proceeds to operation S254, where tagged file mod 354 receives a tagged file for use by deep learning applications. In this example, tagged file mod 354 within store manager program 300 receives parent photo file 113 from client sub-system 112 over network 114. The parent photo file is tagged with metadata directing the production of a deep-learning compatible, reduced-size file where the term size refers to the amount of computer memory required to store the file electronically. In some embodiments of the present invention, when a file is created for use by deep learning applications, the file is tagged for potential modification of the file and the tagged file is received by the tagged file mod for processing. In some embodiments, upon access of a file on a high-speed storage device by a deep learning application, the file is processed for tagging with modification criteria that support minimum required file data for use by deep learning applications or specifically for use by the previously accessing deep learning application. When the file is tagged it is transmitted to the tagged file mod for processing.

In some embodiments of the present invention the tagged files include tagged instructions for generating a stub file to be stored on high-speed storage. Essentially, the tagged file mod receives tagged files for later data management activities that may migrate a file from high speed storage to low speed storage so that deep learning applications may always access the necessary files on a high-speed storage medium. Alternatively, the files that may be used by deep-learning applications are stored with metadata tags for use when the files are designated for migration from high speed to low speed storage. This alternative operation reduces the need for tagged file mod 354. As discussed below, when parent files are identified for migration, the metadata tags form the basis for maintaining a modified version of the parent file in high-speed storage. Sometimes the modified file maintained in high-speed storage is a stub file.

Processing proceeds to operation S256, where identify migration mod 356 identifies a file for migration from high-speed storage to low-speed storage. In this example, identify migration mod 356 identifies parent photo 113 in high speed storage 110 (not shown) at storage sub-system 109 that has characteristics indicative of suitability to migrate to low-speed storage 111. Typical characteristics are relatively low usage compared to other files stored on high-speed storage and relatively high computer memory required to store the file (relatively large file size).

Processing proceeds to operation S258, where tag parameters mod 358 creates a modified file according to the tag parameters. In this example, the tag parameters mod operates responsive to a migration decision at operation S256 associated with parent photo 113 having deep learning tags by creating modified photo 107 according to the tag parameters of the parent photo. Tag parameters may include presetting an extended attribute reducing the data size of the file and performing a check to see if the extended attribute is set to a file to be migrated.

Processing proceeds to operation S260, where high speed storage mod 360 stores the mod file in high speed storage. In this example, high speed storage mod 360 within storage manager program 300 establishes two-way communication with high speed storage 110 using network 114. A check is then performed to see if there is an extended attribute to the parent photo file has been set. If the extended attribute is set, a check is performed to determine whether a temporary stub file exists. If the temporary stub file exists, the temporary file is stored as a stub file in the high-speed storage. If the temporary stub file does not exist, then the parent photo file is targeted for conversion, as specified by the extended attribute, and the converted file is stored in high-speed storage as a stub file.

Processing proceeds to operation S262, where low speed storage mod 362 migrates a file targeted for low-speed storage to low speed storage. In this example, low speed storage mod 362 within storage manager program 300 establishes two-way communication with low speed storage 111 using network 114. Regardless of whether a stub-file is stored or not, after processing according to step S269, the parent photo file is migrated to low speed storage in the same way as existing HSM managed storage.

Processing proceeds to operation S264, where request mod 364 determines that the deep learning app requested a file. In this example, request mod 364 identifies the requesting application and determine if the requesting application is registered in application registry 302.

Processing proceeds to operation S266, where modified file mod 366 sends the modified file to the deep learning app. In this example, modified file mod 366 within storage manager program 300 establishes two-way communication with network 114. In this example, the stub file in high speed storage is returned to the requesting application, a registered deep learning application. If the app is not registered as a deep learning app, file data is copied from low speed storage to high speed storage and the data is returned to the app. This concludes the process operations.

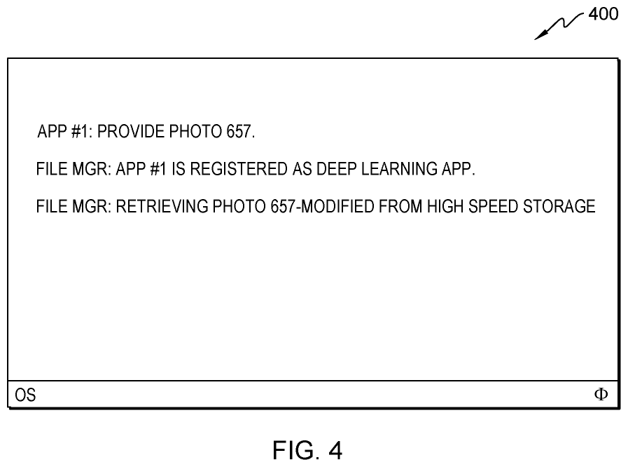

Referring to FIG. 4, example screenshot 400 depicts communications between registered deep learning application, App #1, and a file manager operating according to some embodiments of the present invention. App #1 request photo 657 from File Manager (Mgr). Upon confirming that App #1 is a registered deep learning application, File Mgr retrieves from high speed storage a modified version of the requested photo having qualities required by deep learning applications.

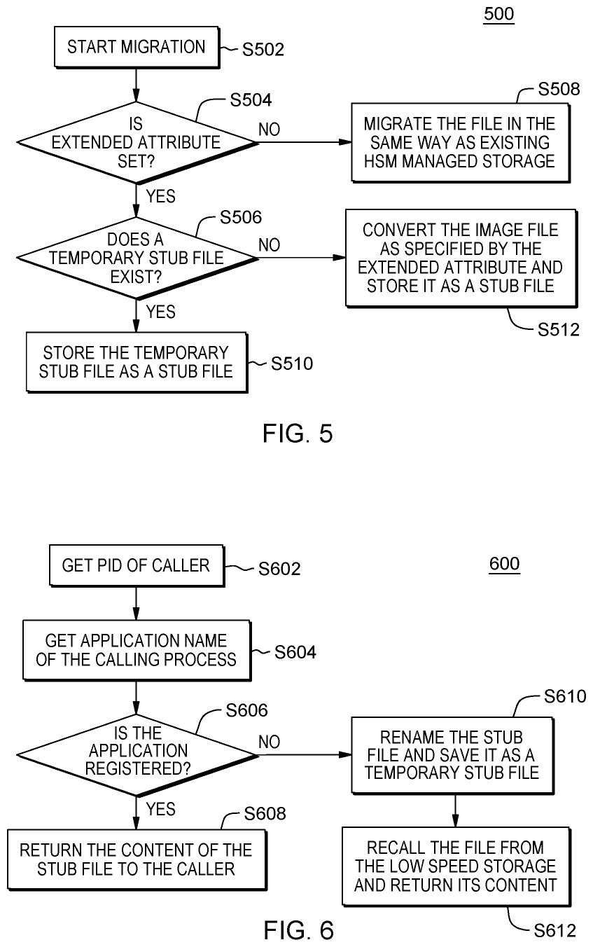

Additional embodiments of the present invention are descripted in reference to FIG. 5, flowchart 500 and FIG. 6, flowchart 600 in the paragraphs below.

### III. Further Comments and/or Embodiments

Some embodiments of the present invention may include one, or more, of the following operations, features, characteristics and/or advantages: (i) manages both resized image and the original image efficiently and transparently from the application's perspective; and (ii) adds the following steps to the migration and recall processes: (a) when storing a file in HSM managed storage, an extended attribute is expected to be added to a file which specifies image width/height or color (black and white), (b) if such an extended attribute is set, the migration process will convert the image, as specified, and store the converted image as a stub file, (c) the name of the deep learning application is expected to be registered, (d) when an HSM managed storage receives a read request, the stub file is returned if the requester is registered to a particular storage, and (e) if the requester is not registered to a particular storage, a file from a low-speed storage is recalled and returns it to the requester.

Some embodiments of the present invention add the following steps to the migration and recall processes on the basis of the fact that in a case of performing leaning by deep learning, for the purpose of image recognition or the like, image data with high resolution is not required: (i) the migration process checks the extended attributes of the file; (ii) if there is a setting related to the size and/or color (grayscale or color) of the file in the extended attributes, the migration process converts the image according to the setting and stores the converted image in a stub file; (iii) the recall process checks whether the read request is from an application that was registered in advance, and if the request is from a registered application, returns the stub file to the caller requesting the readout operation; and (iv) if the request is from an application not registered, the recall process returns the original file from a low-speed storage device to the caller requesting the readout operation.

In the following paragraphs, the migration and recall processes are described in detail.

A method according to an embodiment of the present invention includes the following operations (not necessarily in the following order) pertaining to the migration process: (i) a user, according to an embodiment of the present invention, sets extended attributes of the file with the size and/or color of the stub file (for example, when creating a file whose name is “training_data000.jpg”, the user sets extended attributes by executing a command line like “attr-s stubimgsize−V=10% training_data000.jpg” and/or “attr-s stubimgcolor−V=bw training_data000.jpg”); and (ii) it is premised that a pre-migration process (copying data on a high-speed storage device to a low-speed storage device) has been completed before starting migration.

Referring to FIG. 5, flowchart 500, the migration process is performed by the following operations:

Processing begins at operation S502, the start of migration.

Processing proceeds and checks are made as to whether the extended attribute has been set to the file, operation S504.

Processing continues where if the extended attribute is set, a check is made as to whether the later-described temporary stub file is present, operation S506 (see the description of the recall process). If present, processing will store the temporary file as a stub file, operation S510.

Processing continues where if the temporary stub file is not present, the image file is converted according to the setting presented in the extended attribute, operation S512 (for example, if an attribute like “stubimgsize=10%” is set, reduce the image to 10% of the original and store it as the stub file. Otherwise, if an attribute like “stubimgcolor=bw” is set, convert the image to a black and white image and store it as the stub file).

Processing concludes where if there is no extended attribute setting recognizable, processing will perform migration by the conventional way, operation S508.

Referring to FIG. 6, flowchart 600, the recall process is performed. A user registers the name of an application that performs learning for image recognition using deep learning in the HSM storage system. An example of such name may be “trainingApp.py”.

The recall process according to an embodiment of the present invention is performed by the following operations:

Processing begins where upon receiving a request for reading an image file, get the process ID of the caller is performed (for example by using an API like getpid( )), operation S602. In the previous sentence, PID stands for personal identifiers.

Processing continues where obtaining the application name from the process ID is performed, operation S604 (for example by executing “ps-ef 1 grep <PID>”).

Processing continues where a check is performed as to whether the obtained application name is registered, operation S606.

Processing continues where if the application name is registered, return the stub file to the caller, operation S608.

Processing continues where if the application name is not registered, rename the stub file and save it on a high-speed storage device as a temporally file, operation S610.

Processing concludes where the data stored on the low-speed storage device is copied to the high-speed storage device and the data is returned to the caller, operation S612.

Some embodiments of the present invention recognize the following facts, potential problems and/or potential areas for improvement with respect to the current state of the art: (i) utilizes the mechanism of HSM to provide the following advantageous effects when processing readout requests for the same file; (ii) when a readout request is issued from an application registered in advance, the method returns a stub file to the caller, which has been stored according to the format specified by an extended attribute, to provide necessary data quickly to the application performing learning by deep learning; and (iii) when a readout request is issued from another application, the method can return the original data in the same way as a conventional HSM storage system (that is, recall from the low-speed storage device).

Some embodiments of the present invention recognize: (i) the methods of the present invention have been described as processing image data by way of example; and (ii) can be applied even to a case where the learning data and the original data are not image data (for example, the method can be applied to raw data obtained from a sensor and feature data obtained by analyzing the raw data).

A method according to an embodiment of the present invention, for migrating files from fast (high-speed) storage drives (flash/HDD (hard disk drive)) to slow (low-speed) storage drives (tape) in a storage system (HSM) which is configured to use the fast storage drives as a primary storage and the slow storage drives as a secondary storage respectively, includes the following operations (not necessarily in the following order): (i) when storing a file in the storage system, presetting, to the file, an extended attribute to reduce a data size of the file for an application; (ii) checking whether the extended attribute is set to a file to be migrated, (iii) if the extended attribute is set to the file, checking whether a temporary file, reducing data size of the file, is present in the fast storage drives; (iv) if present, storing, as a stub file, the temporary file in the fast storage drives; (v) if not present, creating the temporary file from the file according to (as specified by) a setting in the extended attribute, and storing, as a stub file, the created temporary file in the fast storage drives; (vi) migrating the file from the fast storage drives to the slow storage drives; and (vii) if the extended attribute is not set to the file, migrating the file from the fast storage drives to the slow storage drives without checking the temporary file.

A method according to an embodiment of the present invention, for recalling files from slow (low-speed) storage drives (tape) to fast (high-speed) storage drives (flash/HDD) in a storage system (HSM) which is configured to use the fast storage drives as a primary storage and the slow storage drives as a secondary storage respectively, includes the following operations (not necessarily in the following order): (i) when storing a file in the storage system, preregistering a name of an application presetting, to the file, an extended attribute to reduce a data size of the file, and storing, as a stub file, a temporary file reducing the data size of the file in the fast storage drives; (ii) when a file is read by an application, checking whether a name of the application is registered; (iii) if registered, returning, to the application, the temporary file stored as a stub file in the fast storage drives; (iv) if not registered, copying data of the file stored in the slow storage drives to the fast storage drives, and returning the data to the application; (v) performs deep learning; and (vi) temporary reducing the data size of the file meets the requirements to perform deep learning.

Some embodiments of the present invention may include one, or more, of the following operations, features, characteristics and/or advantages: (i) skips recalling data and returns a content of a stub file if the data is read by a pre-registered application; (ii) determines if the data should be recalled based on the application that is trying to read the data; and (iii) returns a content of a stub file to a host and skips recalling an original file to improve read performance.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A computer-implemented method comprising:
identifying a parent file stored on a high-speed storage device that may be processed by a first application;
generating a metadata tag for the parent file, the metadata tag including a set of file attributes required by the first application;
responsive to a determination to migrate the parent file from a high-speed storage device to a low-speed storage device, creating a modified file from the parent file, the modified file having attributes matching the set of file attributes described in the metadata tag; and
storing the modified file in the high-speed storage device.

2. The computer-implemented method of claim 1, further comprising:
receiving a request for the parent file from a requesting application;
responsive to determining the requesting application is the first application, sending the modified file to the requesting application.

3. The computer-implemented method of claim 1, further comprising:
registering the first application in a registry for deep-learning applications;
wherein:
the first application is a deep-learning application.

4. The computer-implemented method of claim 1, wherein the parent file is identified when the parent file is requested by the first application.

5. The computer-implemented method of claim 1, wherein:
the parent file is a photographic image; and
the set of file attributes includes a black-and-white colors requirement.

6. The computer-implemented method of claim 1, wherein the modified file is a stub file.

7. The computer-implemented method of claim 1, wherein:
the parent file is a photographic image; and
the set of file attributes includes an image width and/or height requirement.

8. A computer program product comprising:
a set of storage device(s); and
computer code stored collectively in the set of storage device(s), with the computer code including data and instructions to cause a processor(s) set to perform at least the following operations:
identifying a parent file stored on a high-speed storage device that may be processed by a first application,
generating a metadata tag for the parent file, the metadata tag including a set of file attributes required by the first application,
responsive to a determination to migrate the parent file from a high-speed storage device to a low-speed storage device, creating a modified file from the parent file, the modified file having attributes matching the set of file attributes described in the metadata tag, and
storing the modified file in the high-speed storage device.

9. The computer program product of claim 8, wherein the computer code further includes instructions for causing the processor(s) set to perform the following operation(s):
receiving a request for the parent file from a requesting application;
responsive to determining the requesting application is the first application, sending the modified file to the requesting application.

10. The computer program product of claim 8, wherein the computer code further includes instructions for causing the processor(s) set to perform the following operation(s):
registering the first application in a registry for deep-learning applications;
wherein:
the first application is a deep-learning application.

11. The computer program product of claim 8, wherein the parent file is identified when the parent file is requested by the first application.

12. The computer program product of claim 8, wherein:
the parent file is a photographic image; and
the set of file attributes includes a black-and-white colors requirement.

13. The computer program product of claim 8, wherein the modified file is a stub file.

14. The computer program product of claim 8, wherein:
the parent file is a photographic image; and
the set of file attributes includes an image width and/or height requirement.

15. A computer system comprising:
a processor(s) set;
a set of storage device(s); and
computer code stored collectively in the set of storage device(s), with the computer code including data and instructions to cause the processor(s) set to perform at least the following operations:
identifying a parent file stored on a high-speed storage device that may be processed by a first application,
generating a metadata tag for the parent file, the metadata tag including a set of file attributes required by the first application,
responsive to a determination to migrate the parent file from a high-speed storage device to a low-speed storage device, creating a modified file from the parent file, the modified file having attributes matching the set of file attributes described in the metadata tag, and
storing the modified file in the high-speed storage device.

16. The computer system of claim 15, wherein the computer code further includes instructions for causing the processor(s) set to perform the following operation(s):
receiving a request for the parent file from a requesting application;
responsive to determining the requesting application is the first application, sending the modified file to the requesting application.

17. The computer system of claim 15, wherein the computer code further includes instructions for causing the processor(s) set to perform the following operation(s):
registering the first application in a registry for deep-learning applications;
wherein:
the first application is a deep-learning application.

18. The computer system of claim 15, wherein the parent file is identified when the parent file is requested by the first application.

19. The computer system of claim 15, wherein:
the parent file is a photographic image; and
the set of file attributes includes a black-and-white colors requirement.

20. The computer system of claim 15, wherein the modified file is a stub file.
